(19) United States
(12) Patent Application Publication
(10) Pub. No.: US 2006/0014608 A1
(43) Pub. Date: Jan. 19, 2006

(54) CONTINUOUS VARIABLE CONTROL METHODS FOR HYDRAULIC POWERTRAIN SYSTEMS OF A VEHICLE

(76) Inventors: Herman R. Mitchell, Dayton, OH (US); Raymond J. Fleming, Troy, OH (US); Marc McClain, Piqua, OH (US)

Correspondence Address: ARTZ & ARTZ, P.C., 28333 TELEGRAPH RD., SUITE 250, SOUTHFIELD, MI, 48034, US

(21) Appl. No.: 11/160,842

(22) Filed: Jul. 12, 2005

Related U.S. Application Data
(60) Provisional application No. 60/587,575, filed on Jul. 13, 2004.

(51) Int. Cl. B60W 10/04

(52) U.S. Cl. 477/107

(57) ABSTRACT

A method of controlling a powertrain of a vehicle includes the generation of an engine torque versus engine revolutions per minute (RPM) reference for an engine. A current engine speed is determined. A fuel input signal and a continuous variable transmission control signal are generated in response to the engine torque versus engine RPM reference and the current engine speed to maintain an approximately constant engine speed for various engine loading conditions.

### RELATED APPLICATION

The present application claims priority to U.S. Provisional Application Ser. No. 60/587,575, filed Jul. 13, 2004, entitled “Energy Optimization of a System”, which is incorporated by reference herein.

### TECHNICAL FIELD

The present invention relates to vehicle, hybrid, and hydraulic drive powertrain control systems. More particularly, the present invention is related to the efficient and simultaneous control of a vehicle engine and a continuous variable transmission, which may include hydraulic pumps and hydraulic drive motors.

### BACKGROUND OF THE INVENTION

Conventional powertrains operate with significant energy loss, produce significant emissions, and have limited potential in fuel economy improvement. Much of the energy loss is due to a poor match between engine power capacity and average power demand. The load placed on the engine at any given instant is directly determined by the total road load at that instant, which varies between high and low load. To meet acceleration requirements, the engine must be more powerful than the average power required to propel the vehicle. The efficiency of an internal combustion engine varies significantly with load, being best under high loading and worst under low loading. Since engine operation experienced in normal driving is nearly always at the low end of the spectrum, the engine typically operates inefficiently.

Hybrid vehicle systems have been investigated as a means to mitigate the foregoing inefficiencies. A hybrid vehicle system provides a “buffer” between the power required to propel the vehicle and the power produced by the internal combustion engine in order to moderate the variation of power demand experienced by the engine. The effectiveness of a hybrid vehicle system depends on its ability to operate the engine at peak efficiencies and on the capacity and efficiency of the buffer medium. Typical buffer media include electric batteries, mechanical flywheels and hydraulic accumulators.

Although hybrid vehicle systems have provided some improvement in operating efficiencies, there is an opportunity for further improvement. Thus, there exists a need for a powertrain system having improved efficiency and thus fuel economy that is feasible for various vehicle applications.

### SUMMARY OF THE INVENTION

One embodiment of the present invention provides a method of controlling a powertrain of a vehicle. The method includes the generation of an engine torque versus engine revolutions per minute (RPM) reference for an engine. A current engine speed is determined. A fuel input signal and a continuous variable transmission control signal are generated in response to the engine torque versus engine RPM reference and the current engine speed to maintain an approximately constant engine speed for various engine loading conditions.

Another embodiment of the present invention provides a powertrain system control circuit that includes a memory with a stored engine torque versus engine rpm reference. An engine speed sensor generates an engine speed signal. A controller is coupled to the memory and the engine speed sensor and generates a fuel input signal and a continuous variable transmission control signal in response to the engine torque versus engine rpm reference and the engine speed signal to maintain an approximately constant engine speed for various engine loading conditions.

The embodiments of the present invention provide several advantages. One such advantage is the provision of maintaining a constant engine RPM for various loading conditions. This allows for an engine to be operated at a low RPM for multiple loading conditions and to provide efficient fuel consumption.

Another advantage provided by an embodiment of the present invention is the provision of maintaining operation of an engine at a maximum load for a predetermined and constant RPM for multiple loading conditions. In doing so, the stated embodiment continuously maintains the engine operating at a peak fuel efficiency level during both low and high loading conditions.

The present invention itself, together with further objects and attendant advantages, will be best understood by reference to the following detailed description, taken in conjunction with the accompanying drawing.

### BRIEF DESCRIPTION OF THE DRAWINGS

For a more complete understanding of this invention reference should now be had to the embodiments illustrated in greater detail in the accompanying figures and described below by way of examples of the invention wherein:

FIG. 1 is a schematic and block diagrammatic view of a vehicle hydraulic powertrain system in accordance with an embodiment of the present invention.

FIG. 2 is a schematic and block diagrammatic view of the air injection portion of the powertrain system of FIG. 1.

FIG. 3 is a schematic and block diagrammatic view of a vehicle hydraulic powertrain system illustrating a sample single turbocharger configuration in accordance with another embodiment of the present invention.

FIG. 4 is a schematic and block diagrammatic view of a vehicle hydraulic powertrain system illustrating a sample single supercharger configuration in accordance with yet another embodiment of the present invention.

FIG. 5 is a logic flow diagram illustrating a method of operating a vehicle hydraulic powertrain system in accordance with an embodiment of the present invention.

FIG. 6 is a schematic and block diagrammatic view of a vehicle hydraulic powertrain system illustrating a non-gearset configuration in accordance with another embodiment of the present invention.

FIG. 7 is a schematic and block diagrammatic view of a vehicle hydraulic powertrain system illustrating a four-wheel drive configuration in accordance with another embodiment of the present invention.

FIG. 8 is a schematic and block diagrammatic view of a vehicle hydraulic powertrain system illustrating a dual axle non-gearset configuration in accordance with another embodiment of the present invention.

FIG. 9 is a schematic and block diagrammatic view of a vehicle hydraulic powertrain system illustrating a rear dual axle gearset configuration in accordance with another embodiment of the present invention.

FIG. 10 is a schematic and block diagrammatic view of a vehicle hydraulic powertrain system illustrating a six-wheel drive gearset configuration in accordance with another embodiment of the present invention.

FIG. 11 is a schematic and block diagrammatic view of a vehicle hydraulic powertrain system illustrating a six-wheel drive gearset/non-gearset configuration in accordance with another embodiment of the present invention.

FIG. 12 is a schematic and block diagrammatic view of a vehicle hydraulic powertrain system illustrating a six-wheel drive non-gearset configuration in accordance with another embodiment of the present invention.

FIG. 13 is a schematic and block diagrammatic view of a vehicle hydraulic powertrain system incorporating a multi-input powered gearset.

FIG. 14 is a block diagrammatic and schematic view of a powertrain system in accordance with another embodiment of the present invention.

FIG. 15 is a block diagrammatic and schematic view of a powertrain control circuit in accordance with another embodiment of the present invention.

FIG. 16 is a logic flow diagram illustrating a method of controlling a powertrain of a vehicle in accordance with an embodiment of the present invention.

### DETAILED DESCRIPTION

The present invention is disclosed herein primarily in the context of a roadway vehicle such as a truck equipped with a continuously variable hydrostatic drive. However, it will be understood that the invention is also useful both in other vehicular applications and in non-vehicular applications such as power generation stations.

In the following description, various operating parameters and components are described for one constructed embodiment. These specific parameters and components are included as examples and are not meant to be limiting.

The present invention includes an engine, such as a turbocharged diesel engine, in which a high flow of above-atmospheric pressure air is injected into the engine exhaust manifold at distributed locations to simultaneously improve engine power output, exhaust emissions and fuel efficiency. In a sample embodiment, the injected air is provided by a supercharger, at a flow rate of approximately 100-250 cubic feet per minute (CFM). The injected air provides greatly increased exhaust airflow at low engine speeds to dramatically increase the turbocharger boost pressure, which increases engine power output. Improved low speed power output is beneficial in nearly any application including applications, such as a vehicle hydrostatic drive applications, in which the engine is operated at a low and substantially constant speed. The engine exhaust emissions are improved because the injected air: (1) reduces the gas temperature in the exhaust manifold well below the temperature at which NOx emissions are formed; (2) promotes more complete combustion of the air/fuel mixture in the engine to reduce soot; and (3) promotes secondary combustion in the exhaust manifold to reduce other exhaust emissions such as carbon monoxide (CO) and hydrocarbons (HC). The reduction of exhaust emissions through secondary combustion, in turn, allows the engine air fuel ratio to be operated closer to the ideal stoichiometric air/fuel ratio for improved thermodynamic efficiency. The engine fuel efficiency is further improved in constant speed applications, such as in continuously variable hydrostatic drive applications, where losses associated with the acceleration and the deceleration of the engine is minimized.

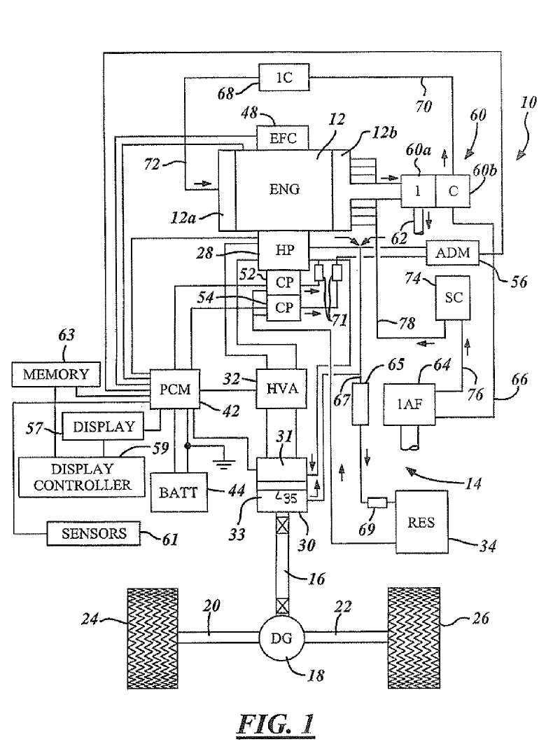

Referring now to FIG. 1, the reference numeral 10 generally designates a hydraulic powertrain system that includes an engine (ENG) 12 and a hydrostatic drive 14. The engine 12 may be in the form of a diesel engine, a combustion engine, a hydraulic engine, an electric engine, or other engines or motors known in the art. The hydrostatic drive 14 couples the power output of the engine 12 to a drive arrangement that includes a driveshaft 16, a differential gearset (DG) 18, drive axles 20, 22 and drive wheels 24, 26.

The hydrostatic drive 14 primarily includes a variable capacity main hydraulic pump (HP) 28 that is driven by the engine 12, a hydraulic drive motor (DM) 30 is coupled to the driveshaft 16, and to a hydraulic valve assembly (HVA) 32. The DM 30 includes two or more hydraulic motors that are ganged together. The ganging of the motors to each other and the coupling of the motors between the DG 18 and the HP 28 provides efficient energy transfer to the drive axles 20, 22. The hydraulic motors may be in a dual arrangement, a tandem arrangement, or in a sequencing arrangement. A dual arrangement refers to the use of two hydraulic motors as primarily described herein. A tandem arrangement refers to the direct coupling of the hydraulic motors in series. A sequencing arrangement refers to the ability to select one or more of the hydraulic motors for operation in any combination and the ability to control the timing thereof.

In one embodiment, the DM 30 includes a first drive motor 31 and a second drive motor 33 that are ganged together in series without use of a gearset. The PCM 42 may control the timing between the drive motors 31, 33 relative to each other to provide efficient coupling therebetween and to prevent undesired harmonic generation due to improper synchronization. The first drive motor 31 is mounted to the second drive motor 33 via an adaptor block 35. The first drive motor 31 is configured and designed for high torque, low speed operation, while the second drive motor 33 is designed for low torque, high speed operation. The drive motors 31, 33 may be operated separately or in combination, such as to provide increased torque at low speeds or when starting from rest or from a zero velocity state. The drive motors 31, 33 may be controlled electronically and/or in response to hydraulic fluid received therefrom. The drive motors may be variable displacement motors.

In a sample embodiment of the present invention, a first drive motor operates in response to an electrical signal received from a controller internal or external to the DM 30 and a second drive motor operates in response to hydraulic fluid received from the first drive motor. The electrical signal may be generated in response to engine speed, throttle position, and vehicle speed. The controller may be the below described PCM 42, may be part of the DM 30, or may be some other vehicle controller. The engine speed, throttle position, and vehicle speed may be acquired from the sensors 61, also described below. Each drive motor within the DM 30 may have an associated controller for controlling displacement thereof.

In another sample embodiment, a first drive motor is operated continuously throughout translation of the corresponding vehicle, such as during both low-speed and high-speed operation, and a second drive motor is selectively operated as desired. This provides increased torque at “take-off” or low speeds when under increased load. This minimizes the amount of activation and deactivation of drive motors and provides desired fuel efficiency.

In general, the HP 28 supplies fluid to the DM 30 by way of HVA 32, while directing a portion of the fluid to a reservoir 34. Note that the DM 30 is not supplied by high-pressure hydraulic fluid stored within a high-pressure accumulator. The hydraulic powertrain system 10 in not using a high-pressure accumulator provides an efficient hydraulic powertrain system that is lighter and can provide improved fuel efficiency. High-pressure hydraulic fluid stored in a high-pressure accumulator is generally or approximately at a fluid pressure greater than 1000 psi. The HP 28, the DM 30, and the HVA 32 are operated by the powertrain control module (PCM) 42. The combination of the HP 28, the HVA 32, the DM 30, and the PCM 42 may be referred to as a hydrostatic continuously variable transmission. The HVA 32 includes a number of solenoid-operated valves that are selectively energized or deenergized to control fluid flow.

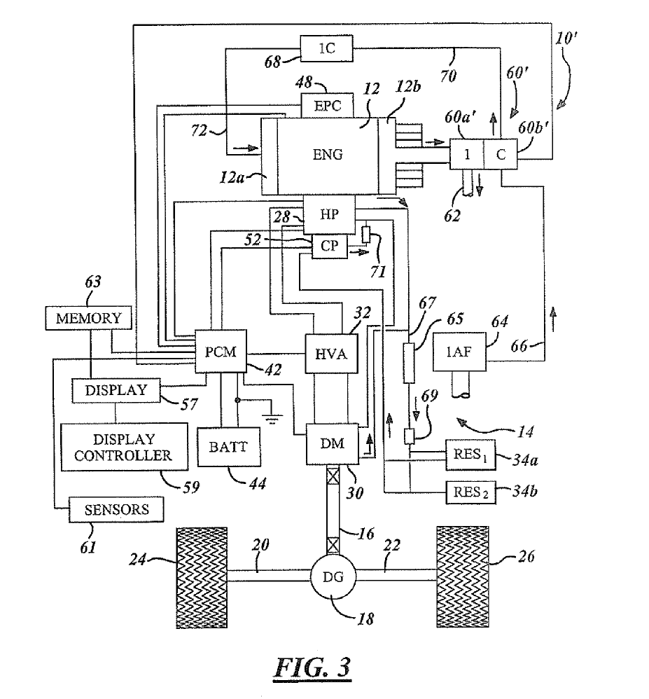

The reservoir 34 is a low-pressure reservoir and is used to store and hold hydraulic fluid. The hydraulic fluid within the reservoir 34 is at a pressure of approximately less than 100 psi. The reservoir 34 may be a single reservoir as shown or may be divided up into multiple stand-alone reservoirs that may be in various vehicle locations. An example dual reservoir system is shown with respect to the embodiment of FIG. 3 in which a first reservoir 34a and a second reservoir 34b are shown.

The PCM 42 is powered by a vehicle storage battery 44, and may include a micro-controller for carrying out a prescribed control of the DM 30 and the HVA 32. The PCM 42 is also coupled to hydraulic pump 28 for controlling its pumping capacity, and to an engine fuel controller (EFC) 48 for controlling the quantity of fuel injected into the cylinders (not shown) of the engine 12. In a particularly advantageous mechanization, PCM 42 controls the capacity of hydraulic pump 28 to satisfy the vehicle drive requirements, while controlling EFC 48 to maintain a low and substantially constant engine speed such as 1000 RPM. The PCM 42 may control the HP 28 and the DM 30 independently, individually, simultaneously, or otherwise to provide a desired or predetermined torque output for a given engine speed for desired traction of the wheels 24, 26.

The PCM 42 and the EFC 48 may be microprocessor based such as a computer having a central processing unit, memory (RAM and/or ROM), and associated input and output buses. The PCM 42 and the EFC 48 may be application-specific integrated circuits or may be formed of other logic devices known in the art. The PCM 42 and the EFC 48 may be a portion of a central vehicle main control unit, an interactive vehicle dynamics module, a control circuit having a power supply, may be combined into a single integrated controller, or may be stand-alone controllers as shown.

The PCM 42 continuously monitors various inputs of the engine 12, the HP 28, and the DM 30 including the speed and torque of the engine 12 and the hydrostatic transmission 14 to electronically manage and simultaneously operate the powertrain system 10 using the lowest energy input. The PCM 42 controls several outputs in response to the inputs including fuel input of the engine 12, displacement of the HP 28, displacement of the DM 30, efficiency curve information, percent engine load, accelerator pedal position, pressures of the HP 28 and DM 30, as well as other various parameters of the powertrain system 10. It is desired that the engine 12 operate at a maximum engine load for a given rpm. The HP 28 and the DM 30 are efficient at their maximum swash plate positions and at desired pressure ranges. The PCM 42 provides such control to achieve desired efficiencies. The configuration of the powertrain system 10, the components utilized therein, and the control methodology provided within the PCM 42 allow for efficient system operation at start, stop, and through various drive modes that allow for the non-use of a high-pressure accumulator.

The hydrostatic drive 14 additionally includes first and second charge pumps (CP) 52, 54 that are ganged together with the HP 28. The charge pumps 52, 54 are driven by the engine 12. The first charge pump 52 supplies control pressure to HP 28 and DM 30 from reservoir 34, and the second charge pump 54 supplies hydraulic fluid from reservoir 34 to an auxiliary hydraulic drive motor (ADM) 56, described below. The charge pumps supply hydraulic fluid at moderate pressures approximately between 100-1000 psi. The charge pumps 52, 54 prevent cavitation of and maintain low friction operation of the HP 28, the DM 30, and the ADM 56. Although two charge pumps are shown any number of charge pumps may be utilized.

The PCM 42 is also coupled to a display 57, which may be operated via a display controller 59, and to sensors 61 and memory 63. The display 57 may be used to indicate to a vehicle operator system pressures, temperatures, maintenance information, warnings, diagnostics, and other system related information. The maintenance information may, for example, include oil life, filter life, pump performance parameters, hydraulic motor performance parameters, engine performance parameters, and other maintenance related information. The display 57 and the display controller 59 may also indicate or provide data logging and historical data for diagnostics including system pressure, system temperature, oil life, maintenance schedule information, system warnings, as well as other logging and historical data.

The display controller 59 displays the stated information in response to data received from the sensors 61 or retrieved from the memory 63. The memory 63 may store the above stated information, as well as other vehicle systems related information known in the art. The memory 63 may be in the form of RAM and/or ROM, may be an integral portion of the PCM 42 or the display controller 59, may be in the form of a portable or removable memory, and may be accessed using techniques known in the art.

The display may be in the form of one or more indicators such as LEDs, light sources, audio generating devices, or other known indicators. The display may also be in the form of a video system, an audio system, a heads-up display, a flat-panel display, a liquid crystal display, a telematic system, a touch screen, or other display known in the art. In one embodiment of the present invention, the display 57 is in the form of a heads-up display and the indication signal is a virtual image projection that may be easily seen by the vehicle operator. The display 57 provides real-time image system status information without having to refocus ones eyes to monitor a display screen within the vehicle.

The display controller 59 may, for example, be in the form of switches or a touch pad and be separate from the display 57, as shown. The display controller 59 may be an integral part of the display 57 and be in the form of a touch screen or other display controller known in the art. The display controller 59 may also be microprocessor based such as a computer having a central processing unit, memory (RAM and/or ROM), and associated input and output buses. The display controller 59 may be application-specific integrated circuits or may be formed of other logic devices known in the art. The display controller 59 may be a portion of a central vehicle main control unit, such as the PCM 42, an interactive vehicle dynamics module, a control circuit having a power supply, may be combined into a single integrated controller, or may be a stand-alone controller as shown.

The sensors 61 may include pressure sensors, temperature sensors, oil sensors, flow rate sensors, position sensors, engine speed sensors, vehicle speed sensors, throttle position sensors, as well as other vehicle system sensors known in the art. In one embodiment of the present invention a pressure sensor, a temperature sensor, and a flow rate sensor are used to indicate the pressure, temperature, and flow rate of the hydraulic fluid received by the DM 30.

The hydrostatic system 14 may also include a heat exchanger 65 for cooling of the hydraulic fluid within return line 67. Cooling of the hydraulic fluid aids in providing efficient operation of the hydrostatic system 14 and increases operating life of the components and devices contained therein. The heat exchanger 65 may be of various types and styles and may be located in various locations within a vehicle. The heat exchanger 65 may be in the form of an air-to-oil heat exchanger or a liquid-to-oil heat exchanger. Thus, the heat exchanger may be cooled by air and/or by a liquid coolant, such as water, propylene glycol, or other coolant or a combination thereof. The heat exchanger 65 may be associated solely with the cooling of hydraulic fluid within the return line 67 or may be used for cooling of other fluids. In one embodiment of the present invention, the heat exchanger 65 is shared and is used to cool hydraulic fluid within the hydrostatic system 14, as well as oil within the engine 12. The heat exchanger 65 may be in the form of a radiator and may be cooled by a fan (not shown).

The hydrostatic system 14 may further include particulate filters with various pressure ratings. In the embodiment shown a low-pressure return line filter 69 is coupled between the reservoir 34 and the heat exchanger 65 and is used to filter the hydraulic fluid in return line 67. Charge pump filters 71 are coupled between the charge pumps 52, 54 and the HP 28, the DM 30, and the ADM 56, respectively, and are used to filter hydraulic fluid entering the HP 28, the DM 30, and the ADM 56. The charge pump filters 71 are rated for higher fluid pressures than that of the low-pressure filter 69. Although a specific number of filters are shown, any number of filters may be utilized.

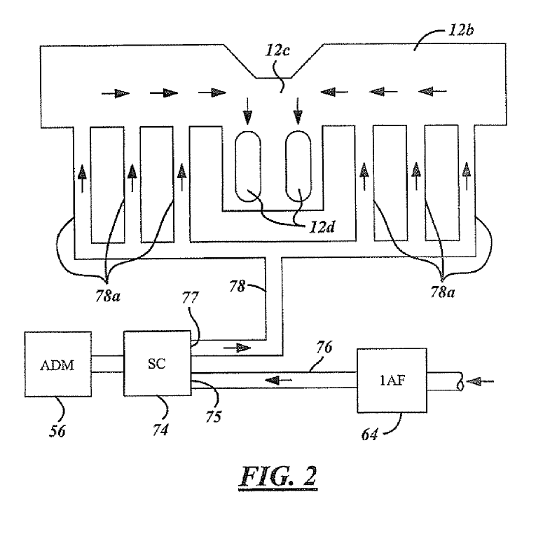

Referring now also to FIG. 2, the engine 12 includes an intake manifold 12a that receives intake air. An exhaust manifold 12b collects the engine cylinder exhaust gases. FIG. 2 illustrates the exhaust manifold 12b of a typical diesel engine having an in-line cylinder configuration. The cylinder exhaust gases are discharged into the left and right portions or runners of the exhaust manifold 12b, and are channeled toward a central collection plenum 12c with one or more exit ports 12d. In a typical application, the left-hand and right-hand portions of the exhaust manifold 12b may be separate castings that are individually bolted to the engine 12. In any event, the exhaust gas exit ports 12d lead to the impeller section (1) 60a of an exhaust-driven turbocharger 60 en route to an exhaust pipe or header 62. The impeller section 60a drives a compressor section (C) 60b of the turbocharger 60, which compresses atmospheric pressure air for delivery to the intake manifold 12a. The inlet atmospheric pressure air passes through an inlet air filter (IAF) 64, and is delivered to the compressor section 60b via low-pressure conduit 66. The high-pressure air at the outlet of compressor section 60b is passed though an intercooler 68 by the conduits 70, 72 en route to the intake manifold 12a.

In a conventional turbocharged diesel engine, the gas temperature in the exhaust manifold is well above 1700° F., the temperature above which NOx emissions are readily formed. Moreover, since a conventional turbocharger produces little boost at low engine speeds, the air/fuel ratio in the engine cylinders becomes too rich when the fuel delivery is increased to accelerate the engine. As a result, partially consumed fuel is discharged into the exhaust manifold, producing objectionable levels of soot until the engine speeds up and the turbocharger produces sufficient boost. The high levels of soot formation and the low speed power deficiency can be addressed by some external means that speeds up the turbocharger impeller. The increased speed of the turbocharger impeller provides the intake air boost needed, but at the expense of increased NOx formation due to high cylinder and exhaust manifold temperatures and long residence times. The embodiment described below with respect to FIG. 2, on the other hand, provides an approach that not only achieves low speed soot and power improvements, but also achieves significant improvements in NOx emissions and fuel economy.

A mechanically driven supercharger (SC) 74 delivers high-pressure air to the exhaust manifold 12b at distributed locations along its length. The inlet air is passed through an inlet air filter 64 (which may be the same inlet air filter used by the turbocharger 60, or a different inlet air filter), and is delivered to the supercharger inlet 75 by a conduit 76. The supercharger outlet 77 is coupled to a high-pressure plenum 78 from which a number of branches 78a inject the air into distributed locations of the exhaust manifold 12b, at an approximate flow rate of 100-250 CFM. In one embodiment, the number of branches 78a is equal to the number of engine cylinders discharging exhaust gases into the manifold 12b, and the air is injected in proximity to the points at which the exhaust gases are discharged into the manifold 12b. The temperature of the air injected into exhaust manifold 12b by supercharger 74 is approximately 307° F., effectively cooling the exhaust gasses to approximately 350° F., which is well below temperatures at which NOx emissions are readily formed. Interestingly, this also has the effect of reducing the required cooling capacity of the liquid coolant that is circulated through the engine 12, thereby reducing the engine power requirements for coolant pumping and radiator airflow.

In the illustrated embodiment, the supercharger 74 is driven by a hydraulic accessory drive motor (ADM) 56 powered by hydraulic fluid from charge pump 54 as mentioned above. This is particularly advantageous in the context of a hydrostatic vehicle drive since the additional hydraulic fluid pressure for powering the supercharger 74 is available at very little extra cost, and the capacity of ADM 56 can be controlled by the PCM 42 as indicated to optimize the rotational speed of the supercharger 74 regardless of the engine speed. Furthermore, the supercharger 74 may be located remote from the engine 12 as implied in FIGS. 1-2, which allows the supercharger 74 to be mounted in a location that provides cooler inlet air and easier mounting and routing of the air conduits. Of course, the supercharger 74 can alternatively be driven by a different rotary drive source such as an electric or pneumatic motor, or the engine 12.

In summary, the air injection system of the present invention simultaneously contributes to improved exhaust emissions, engine power output and fuel efficiency, and allows a turbocharged diesel engine to be well suited to highly efficient low constant speed operation in a hydrostatic vehicle drive.

Referring now to FIG. 3, a schematic and block diagrammatic view of a vehicle hydraulic powertrain system 110′ illustrating a sample single turbocharger configuration in accordance with another embodiment of the present invention is shown. The powertrain system 110′ is similar to the powertrain system 10, however the turbocharger 60 is replaced with a high-efficiency turbocharger 60′, which eliminates the need for the supercharger 74 and associated componentry. The turbocharger has impeller 60a′ and compressor 60b′. The turbocharger 60′ may be configured for efficient operation at low constant engine speeds. The engine speed is controlled by the PCM 42 such that a low constant speed is maintained.

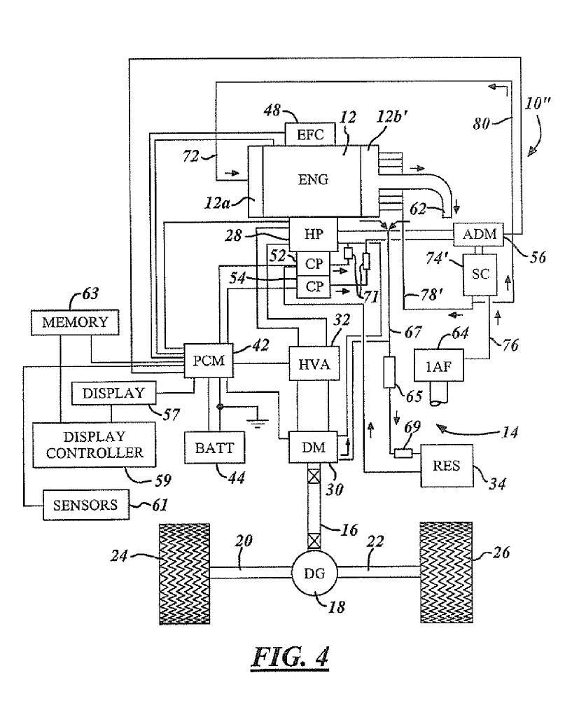

Referring now to FIG. 4, a schematic and block diagrammatic view of a vehicle hydraulic powertrain system 10″ illustrating a sample single supercharger configuration in accordance with another embodiment of the present invention is shown. The powertrain system 10″ is also similar to the powertrain system 10. However a supercharger 74′ is utilized in replacement of the supercharger 74 and is configured to supply air to the intake manifold 12a. In supplying air to the intake manifold 12a the turbocharger 60 is not utilized and is thus removed. Also, since the supercharger 74′ does not draw air from the exhaust manifold 12b′ the intercooler 68 is also eliminated. The plenum 78′ includes an additional branch 80 over that of the plenum 78, which supplies the air to the intake manifold 12a. The exhaust manifold 12b′ is also modified to couple directly to the header or exhaust pipe 62.

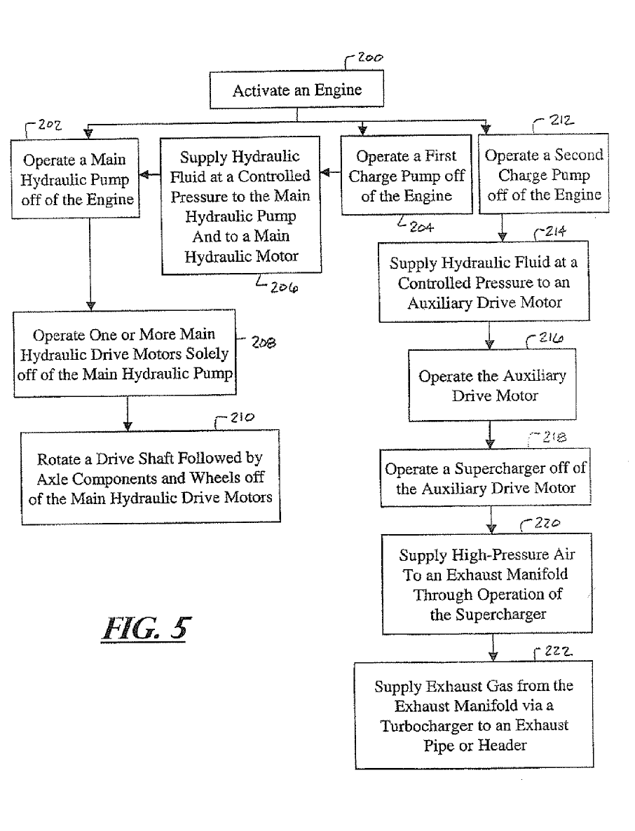

Referring now to FIG. 5, a logic flow diagram illustrating a method of operating a vehicle hydraulic powertrain system in accordance with an embodiment of the present invention is shown. Although steps 200-222 are described primarily with respect to the embodiments of FIGS. 2 and 3, the method of FIG. 4 may be easily modified for other embodiments of the present invention.

In step 200, an engine is activated, such as the engines 12. The engine may be activated via the PCM, or by other methods known in the art.

In step 202, a main hydraulic pump, such as the HP 28, is operated or driven directly off of the engine. The main hydraulic pump may be coupled to a crankshaft of the engine and receive rotational energy therefrom.

In step 204, a first charge pump, such as the CP 52, is also operated off of the engine. The first charge pump may be ganged to the main hydraulic pump and also operate in response to rotation of a crankshaft of the engine. In step 206, the first charge pump supplies control pressure to the main hydraulic pump and to a main hydraulic motor, such as the DM 30. In steps 204 and 206, the first charge pump may be operated and the control pressure may be adjusted by a PCM, such as the PCM 42. The control pressure may also be adjusted mechanically within the charge pump.

In step 208, one or more main hydraulic motors, such as the motors of the DM 30, are operated off of high-pressure hydraulic fluid received from the main hydraulic pump. The flow direction of the high-pressure hydraulic fluid may be adjusted by a hydraulic valve assembly, such as the hydraulic valve assembly 32.

In step 210, a driveshaft followed by components of an axle assembly and the corresponding wheels of a vehicle are rotated in response to rotational energy received from the main hydraulic motors. Components of an axle assembly may refer to, for example, the DG 18 and the axles 20 and 22. With respect to the embodiment of FIG. 1, the DM 30 rotates the driveshaft 16, the DG 18, the axles 20, 22, and the wheels 24, 26 for translation of the corresponding vehicle in a forward or reverse direction.

In step 212, a second charge pump, such as the CP 54, is operated similarly as the first charge pump. In step 214, the second charge pump supplies hydraulic fluid to an auxiliary drive motor, such as the ADM 56, at a controlled pressure, which may also be adjusted by the a PCM or internally controlled.

In step 216, the auxiliary drive motor is activated and operated utilizing the hydraulic fluid received from the second charge pump. The auxiliary drive motor may also be activated and operated via a PCM, such as the PCM 42.

In step 218, a supercharger, such as the supercharger 218, is operated off of the auxiliary drive motor. In step 220, the supercharger draws air through an intake filter and injects it into an exhaust manifold. In step 222, a turbocharger, such as the turbocharger 60, is operated in response to exhaust received from the exhaust manifold. The turbocharger directs and or injects exhaust gas into an intake manifold and into an exhaust pipe.

The above-described steps are meant to be illustrative examples; the steps may be performed sequentially, synchronously, simultaneously, or in a different order depending upon the application.

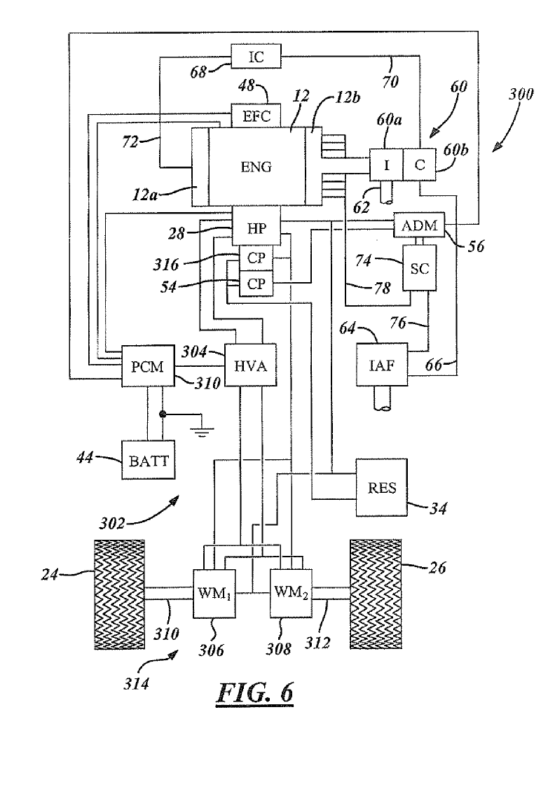

The hydraulic drive motors and the hydraulic wheel motors of FIGS. 6-13 described below may each include one or more hydraulic motors similar to the DM 30. When more than one hydraulic motor is utilized they may be ganged as described above with respect to DM 30.

Also, the heat exchanger 65 and the filters 69 and 71 are not shown in FIGS. 6-12 for simplicity of illustration. The heat exchanger 65, the filters 69 and 71, and other similar devices may be incorporated within the embodiments of FIGS. 6-12 as desired. Also, in FIGS. 6-12 the signal control lines between the PCMs and the hydraulic drive motors and the hydraulic wheel motors are also not shown for simplicity of illustration, but may be included and are designed for control efficiency.

Additionally, the term “wheel pair axle” refers to a set of front end or rear drive components that include a pair of wheels that are positioned laterally relative to each other and are approximately in the same fore and aft position on a vehicle. For example, a standard four-wheel vehicle has two front wheels and two rear wheels. The front wheels are part of a first wheel pair axle and the two rear wheels are part of a second wheel pair axle. The term wheel pair axle does not imply that the wheels contained in that pair are on or rotated by the same axle. However, the wheels within a wheel pair axle may be rotated by one or more driveshafts, by one or more hydraulic drive motors, such as one or more of DM 30, or by a pair of hydraulic wheel motors, as shown in FIGS. 1 and 3-4 described above, as well as in FIGS. 6-12 described below.

Note also that although in FIGS. 6-13 a single charge pump is shown as supplying hydraulic fluid to multiple hydraulic drive motors and to multiple hydraulic wheel motors, any number of charge pumps may be utilized.

Referring now to FIG. 6, a schematic and block diagrammatic view of a vehicle hydraulic powertrain system 300 illustrating a non-gearset configuration in accordance with another embodiment of the present invention is shown. The powertrain system 300 has a hydrostatic transmission 302 that includes the HP 28, an HVA 304, a first hydraulic wheel motor (WM) 306, a second hydraulic wheel motor 308, and a PCM 310. The HVA 304 and the PCM 310 are similar to the HVA 32 and the PCM 42, respectively, and are configured for the WMs 306, 308. The WMs 306, 308 are coupled to and rotate the axles 310, 312, which in turn rotate the wheels 24, 26. The WMs 306, 308 may be separated by the axles 310, 312 or by a vehicle suspension (not shown). The WMs 306, 308 may also be ganged together or may be coupled via a transfer case or gearbox. The combination of the WMs 306, 308, the axles 310, 312, and the wheels 24, 26 form a single rear wheel pair axle 314. The charge pump 316 is similar to the CP 52, but is also configured for the WMs 306 and 308.

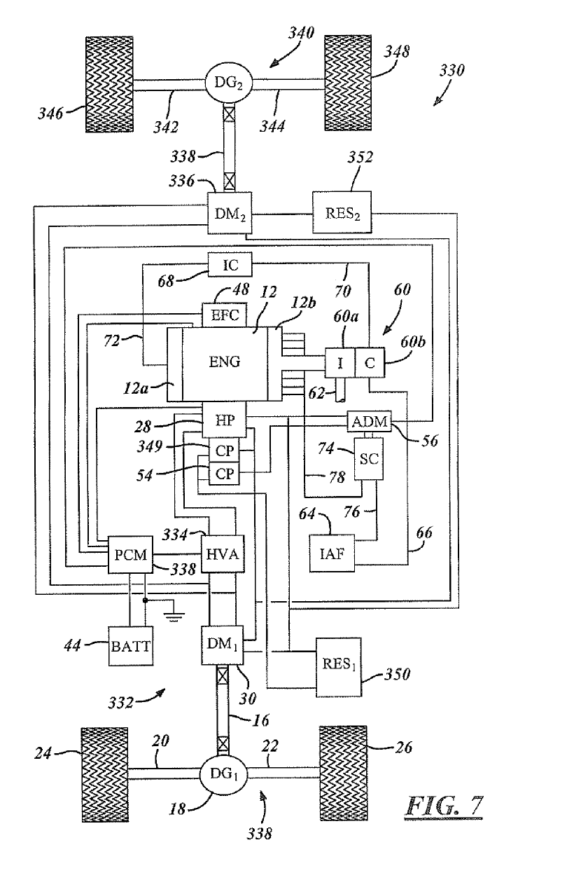

Referring now to FIG. 7, a schematic and block diagrammatic view of a vehicle hydraulic powertrain system 330 illustrating a four-wheel drive configuration in accordance with another embodiment of the present invention is shown. The powertrain system 330 has a hydrostatic transmission 332 that includes the HP 28, the HVA 334, the first hydraulic DM 30, the second hydraulic drive motor 336, and the PCM 338. The DM 30 is coupled to the first driveshaft 16, which rotates components within a rear wheel pair axle 338. The rear wheel pair axle 338 includes the axles 20, 22, and the wheels 24, 26. The second DM 336 is coupled to a second driveshaft 338, which rotates components within a front wheel pair axle 340. The front wheel pair axle 340 includes axles 342, 344, and wheels 346, 348. The HVA 334 and the PCM 338 are similar to the HVA 32 and the PCM 42, respectively, and are configured for the DMs 30, 336. The charge pump 349 is similar to the CP 52, but is also configured for the DMs and 336.

In the sample embodiment of FIG. 7, multiple reservoirs are shown. A first reservoir 350 supplies hydraulic fluid to the CPs 54 and 349 and receives hydraulic fluid from the HP 28, the ADM 56, and the DM 30. A second reservoir 352 also supplies hydraulic fluid to the CPs 54 and 349, but receives hydraulic fluid from the HP 28, the ADM 56, and the DM 336. The reservoirs 350 and 352 allow for shorter supply lines and are generally smaller than the reservoir 34.

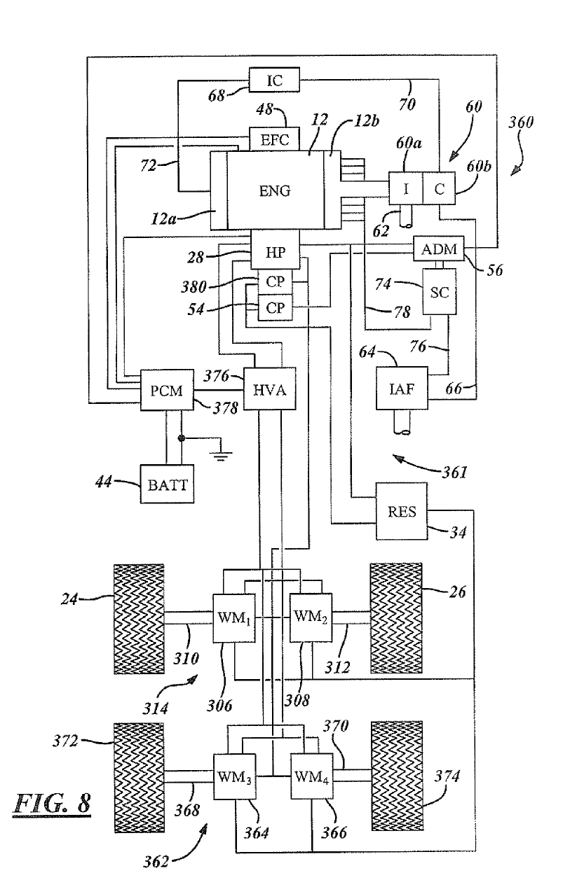

Referring now to FIG. 8, a schematic and block diagrammatic view of a vehicle hydraulic powertrain system 360 illustrating a dual axle non-gearset configuration in accordance with another embodiment of the present invention is shown. The powertrain system 360 has a hydrostatic transmission 361 and is similar to the powertrain system 300, but includes the first rear wheel axle 314 and a second rear wheel axle 362. A second rear wheel axle 362 includes the WMs 364, 366, axles 368, 370, and wheels 372, 374. The WMs 364, 366 may also be separately utilized, as shown, ganged together, or coupled via a transfer case or gearbox. The HVA 376 and the PCM 378 are similar to the HVA 304 and the PCM 310, respectively, and are configured for the WMs 306, 308, 364, 366. The charge pump 380 is similar to the CP 316, but is also configured for the WMs 306, 308, 364, 366.

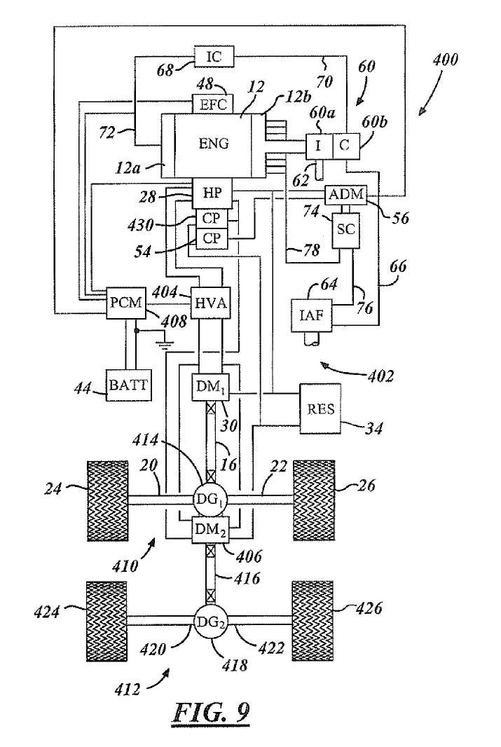

Referring now to FIG. 9, a schematic and block diagrammatic view of a vehicle hydraulic powertrain system 400 illustrating a rear dual axle gearset configuration in accordance with another embodiment of the present invention is shown. The powertrain system 400 has a hydrostatic transmission 402 that includes the HP 28, the HVA 404, the first DM 30, the second DM 406, and the PCM 408. The powertrain system also includes a first rear wheel pair axle 410 and a second rear wheel pair axle 412. The first wheel pair axle 410 includes a gearset 414, the axles 20, 22, and the wheels 24, 26. The second wheel pair axle 412 is coupled to the first wheel pair axle 410 via the second DM 406 and a second driveshaft 416. The second wheel pair axle 412 includes a second gearset 418, axles 420, 422, and wheels 424, 426. The first gearset 414 is configured to couple the first driveshaft 16 and the second DM 406. This configuration aids in maintaining synchronization of the DMs 30, 406, such that the wheels 24, 26, 424, 426 rotate in agreement. The first gearset 414 may not be coupled to the second DM 406 and timing between the DMs 30, 406 may be controlled by the PCM 408. The HVA 404, the PCM 408, and the charge pump 430 are configured for the DMs 30, 406.

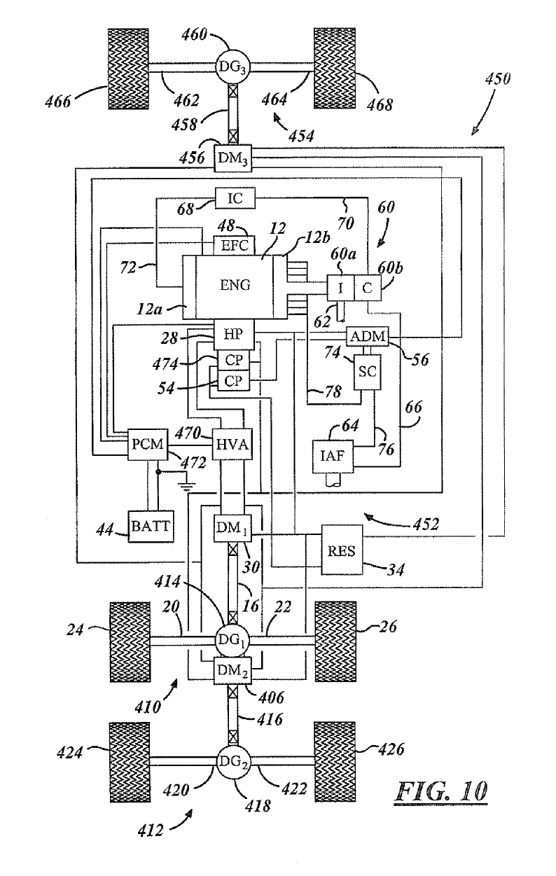

Referring now to FIG. 10, a schematic and block diagrammatic view of a vehicle hydraulic powertrain system 450 illustrating a six-wheel drive gearset configuration in accordance with another embodiment of the present invention is shown. The powertrain system 450 has a hydrostatic transmission 452 and is similar to the powertrain system 400, but also includes a front wheel pair axle 454. The front wheel pair axle 454 includes a third drive motor 456, a third driveshaft 458, a third gearset 460, axles 462, 464, and wheels 466, 468. The HVA 470, the PCM 472, and the charge pump 474 are configured for the DMs 30, 406, and 456.

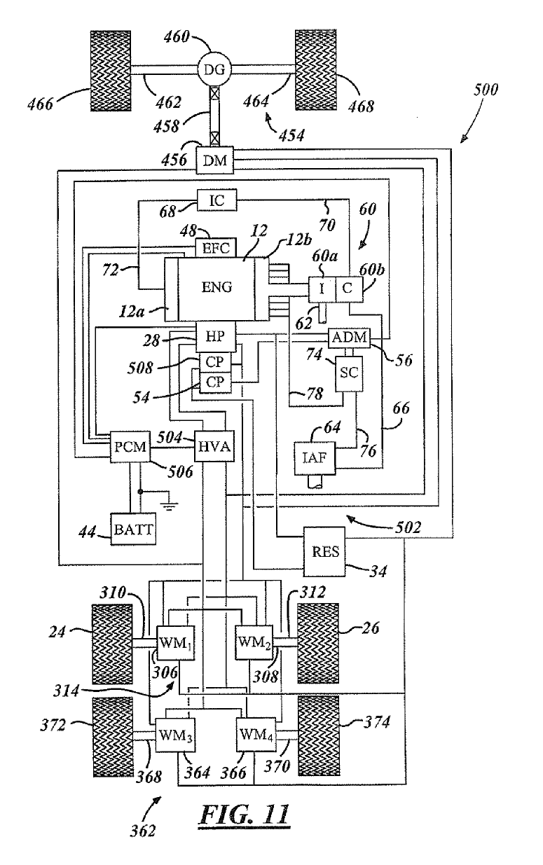

Referring now to FIG. 11, a schematic and block diagrammatic view of a vehicle hydraulic powertrain system 500 illustrating a six-wheel drive gearset/non-gearset configuration in accordance with another embodiment of the present invention is shown. The powertrain system 500 has a hydrostatic transmission 502 and is similar to the powertrain system 360, but like powertrain system 450 also includes the front wheel pair axle 454. The HVA 504, the PCM 506, and the charge pump 508 are configured for the WMs 306, 308, 368, 370, and the DM 456.

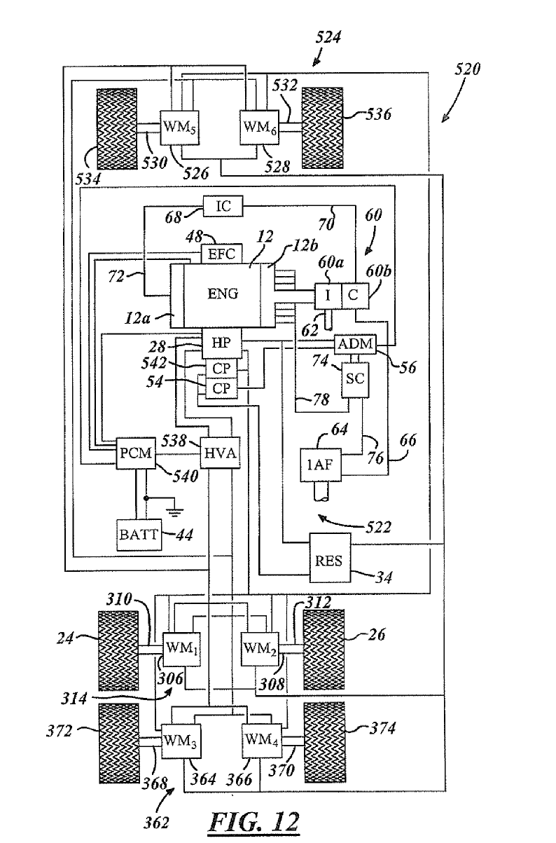

Referring now to FIG. 12, a schematic and block diagrammatic view of a vehicle hydraulic powertrain system 520 illustrating a six-wheel drive non-gearset configuration in accordance with another embodiment of the present invention is shown. The powertrain system 520 has a hydrostatic transmission 522 and is also similar to the powertrain system 360, but further includes a front non-gearset wheel pair axle 524. The front non-gearset axle 524 includes a fifth hydraulic wheel motor 526, a sixth hydraulic wheel motor 528, corresponding axles 530, 532, and wheels 534, 536. The WMs 526, 528 may also be separately utilized, as shown, ganged together, or coupled via a transfer case or gearbox. The HVA 538, the PCM 540, and the charge pump 542 are configured for the WMs 306, 308, 368, 370, 526, 528.

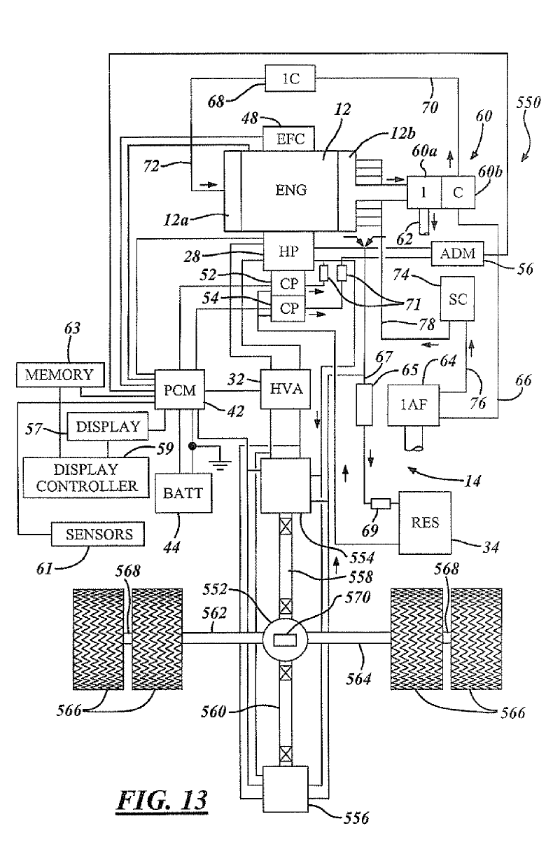

Referring now to FIG. 13, a schematic and block diagrammatic view of a vehicle hydraulic powertrain system 550 incorporating a multi-input powered gearset 552 is shown. The powertrain system 550 includes a pair of hydraulic drive motors 554 and 556. The drive motors 554, 556 may include one or more drive motors ganged together, similar to the DM 30. The drive motors 554, 556 are coupled and supply power to the multi-input gearset 552 via driveshafts 558 and 560, respectively. The multi-input gearset 552 rotates a pair of axles 562 and 564, which in turn rotate two pairs of wheels 566. Wheel transfer axels 568 reside between each pair of the wheels 566. Although 4 wheels are shown in a dual axel configuration, any number of wheels may be utilized.

The PCM 42 is coupled to the multi-input gearset 552 and selects the amount of power to be received by the wheels 566 via a power divider 570 of the multi-input gearset 552. The power divider 570 may be in the form of, for example, one or more solenoids and selects one or more of the drive motors 554, 556 to receive power therefrom. The power divider 570 may receive power from one or both of the drive motors 554, 556. The power divider 570 may be variable in design in that it may adjust the level of power received from each of the drive motors 554, 556. The power divider 570 performs such selection in response to a signal received from the PCM 42.

In another embodiment, the power divider 570 may systematically and dynamically select and adjust the amount power received from the drive motors 554, 556 without receiving a signal from the PCM. The power divider 570 may be a “smart” device and contain logic or other electrical and mechanical devices for performing such selection and adjustment. The selection and adjustment, for example, may be performed in response to vehicle speed or engine rpm.

Use of the power divider 570 and multiple drive motors, which are separately coupled via associated driveshafts and/or ganged together, provides a wider range of operation without “weak spots”. Weak spots refer to temporary periods or transitions when a decreased amount of torque is available. The use of the power divider 570 also eliminates the need for a clutch to disengage one or more of the drive motors, thus minimizing system components and complexity.

The embodiment with respect to FIG. 13 allows for hydraulic drive motors of different size, having different displacement and power characteristics, to be incorporated and coupled to a single gearset without the direct coupling or ganging of the drive motors.

As an example, each of the drive motors 554, 556 may be utilized from a rest position to aid in accelerating the vehicle from rest. As the vehicle speed increases one of the motors 554 or 556 may be deactivated. The first drive motor 554 may be a high-speed/low-torque motor and the second drive motor 556 may be a low-speed/high-torque motor. As the vehicle speed increases the second drive motor 556 may be deactivated. The second drive motor 556 may be entirely deactivated at a predetermined vehicle speed or the second motor may be gradually deactivated as the vehicle speed increases. As an example, the second drive motor 556 may be deactivated at a wheel speed of approximately 200-260 rpm. The PCM 42 or the power divider 570 may utilize vehicle speed or wheel speed tables to determine when and to what extent to deactivate the second drive motor 556.

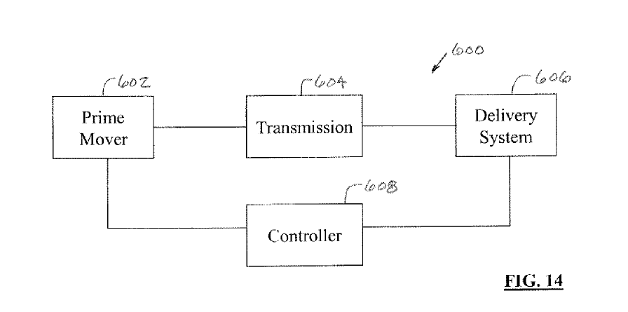

Referring now to FIG. 14, a block diagrammatic and schematic view of a powertrain system 600 in accordance with an embodiment of the present invention is shown. The powertrain system 600 includes a prime mover 602, a transmission 604, and a delivery system 606. The prime mover 602 provides an input torque to drive the transmission 604. The transmission 604 converts the input from the prime mover 602 to an output torque for driving the delivery system 606 to perform work as designed. The transmission 604 may be a hydrostatic or continuously variable transmission, such as the transmissions 14, 302, 332, 361, 402, 452, 502, and 522. The powertrain system 600 may, for example, drive wheels for vehicular movement, pump fluids and/or gases, actuate lifting equipment, or perform other types of work. A controller 608 is coupled to the prime mover 602, the transmission 604, and the delivery system 606 and simultaneously controls the various inputs and outputs of the stated devices to maintain a minimal energy input to the transmission 604 to perform the tasks desired. The controller 608 may be in the form of or be used in replacement of one of the controllers 42, 310, 338, 378, 408, 472, 506, and 540.

The prime mover 602 may be any suitable machine or device that provides input torque for the transmission 604. Examples of a suitable prime mover include an electric motor, an internal combustion engine, and a hydraulic and/or air (pneumatic) motor. The transmission 604 may be any suitable device, which can alter the input torque of the prime mover 602 to a desired output torque for driving the delivery system 606.

An example of a suitable powertrain system includes the use of an internal combustion engine that may function as the prime mover and variable hydraulic rotary axial pumps and variable hydraulic rotary axial piston motors that may function in combination as the transmission. The hydraulic pumps are driven by the prime mover 602. The hydraulic motors function as the delivery system and are attached to a drive axle or the wheels of the vehicle. The transmission 604 decouples the prime mover or engine speed from the road or vehicle speed and allows the engine to operate at low speeds.

The controller 608 continuously monitors the inputs to the primary mover 602 and to the transmission 604 and in response thereto electronically and simultaneously manages and adjusts the speed and torque of the primary mover 602 and the transmission 604 to operate the system with the minimum energy input from the primary mover 602. This allows for reduced engine revolutions per minute (and per mile driven), fewer combustion events per mile driven, lower fuel consumption, lower emissions of undesirable by products of combustion per mile driven, lower engine temperatures, which are also a byproduct of engine combustion, and increased engine operating life.

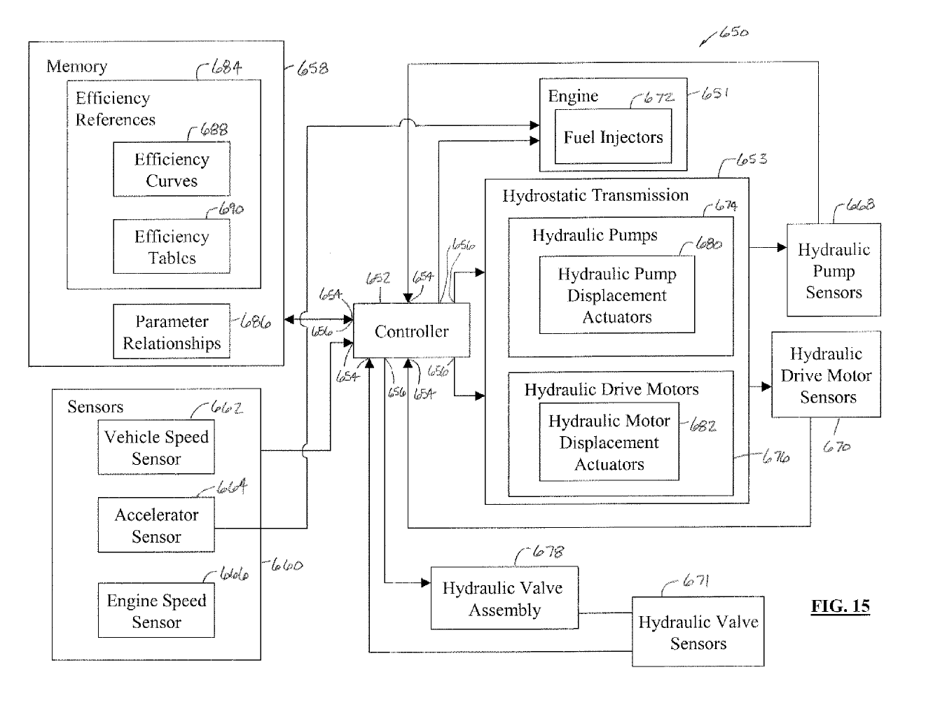

Referring now to FIG. 15, a block diagrammatic and schematic view of a powertrain control circuit 650 in accordance with an embodiment of the present invention is shown. The powertain control circuit 650 may be used to control operation of both an engine 651 and a hydrostatic or continuously variable transmission 653 having one or more hydraulic pumps and hydraulic drive motors. An example engine 12 and hydrostatic transmissions 14, 302, 332, 361, 402, 452, 502, 522, hydraulic pumps, 28, 52, 54, 316, 349, 380, 430, 508, and drive motors 30, 31, 33, 306, 308, 336, 364, 366, 406, 456, 526, 528, 554, and 556 are described above. The powertrain control circuit 650 includes a controller 652, such as the controller 608 or the like, which has multiple inputs 654 and multiple outputs 656. The controller 652 also includes or is coupled to a memory 658.

The inputs 654 include various signals from the memory 658 and from a sensor complex 660. The controller 652 is coupled to a vehicle speed sensor 662, an accelerator sensor 664, an engine speed sensor 666, hydraulic pump sensors 668, hydraulic drive motor sensors 670, and may be coupled to other sensors known in the art. The sensors 662, 664, 666, 668, 670, and 671 may or may not be part of the sensor complex 660. The vehicle speed sensor may be of various type and styles known in the art and may, as a couple of examples, include a drive shaft rotation sensor or a wheel speed sensor. The accelerator sensor 664 may be coupled to both the controller 652 and to the fuel injectors 672 of the engine 651, as shown, or simply to the controller 652. The accelerator sensor 664 may be in the form of an accelerator pedal position sensor, a drive-by-wire acceleration sensor, or some other accelerator sensor known in the art. The engine speed sensor 666 is coupled to the engine 651 or elsewhere and provides an indication of a current actual engine speed. The engine speed sensor 666 may be a rotary sensor, an optical sensor, a camshaft or crankshaft sensor, a flywheel sensor, or other engine speed sensor known in the art.

The hydraulic pump sensors 668 and the hydraulic drive motor sensors 670 may be used to sense pressures, displacements, and speeds of hydraulic pumps 674 and hydraulic drive motors 676 within the hydrostatic transmission 653 and powertrain system 650. The sensors 668 and 670 provide status information in the form of feedback signals to the controller 652. Various types and styles of hydraulic pump sensors and the hydraulic drive motor sensors may be used. The sensors 668 and 670 may be coupled to or within the hydraulic pumps 674 and drive motors 676, coupled to hydraulic fluid lines (not shown) that extend to and from the hydraulic pumps 674 and the drive motors 676, coupled to reservoirs or hydraulic fluid tanks (not shown), or elsewhere in the powertrain system 650. The sensors 668 and 670 may also be coupled to a hydraulic valve assembly 678 or to various hydraulic valves therein or elsewhere and provide valve position feedback to the controller 652. The sensors 668 and 670 may be used to detect the position of hydraulic pump displacement actuators 680 and of hydraulic motor displacement actuators 682.

The memory 658 stores various efficiency references 684 and may also include various parameter relationships 686. For example, the efficiency references 684 may include efficiency curves 688 or efficiency tables 690 relating various parameters to allow the controller 652 to generate output signals to the fuel injectors 672, the hydraulic pumps 674 and the drive motors 676. One example efficiency curve is that of engine torque plotted in relation to engine RPM. The controller 652 may plot or compare engine torque to engine RPM to obtain a desired efficient operation of the engine 651. Other example efficiency curves include hydraulic pump and drive motor pressure, displacement, and speed curves as can be determined by one skilled in the art and tend to be specific to a particular pump, motor, and hydrostatic system used. The individual efficiencies of the hydraulic pumps 674 and the drive motors 676 may be plotted or compared against a swash plate angle, of a hydraulic pump, and hydraulic pressure and/or accelerator pedal positioning to obtain a desired efficient operation. As another example, the controller 652 or memory 658 may have stored a relationship for percent engine load, which can be determined from accelerator position and engine RPM.

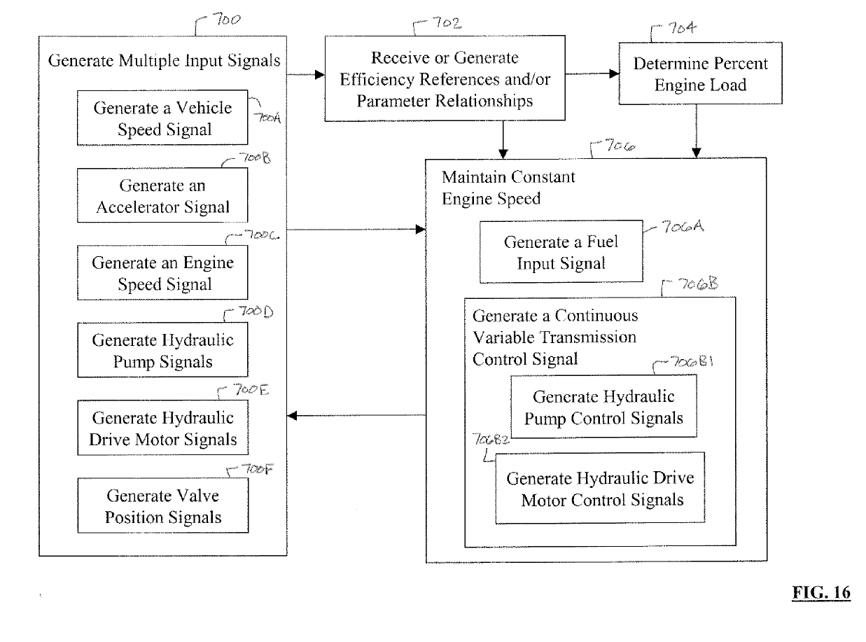

Referring now to FIG. 16, a logic flow diagram illustrating a method of controlling a powertrain of a vehicle is shown. Although the method of FIG. 16 is primarily described with respect to the control circuit 650 and embodiment of FIG. 15, it may be applied to other control circuits and embodiments of the present invention. Also, the following steps 700-708 do not address control of charge pumps, such as charge pumps 52, 54, 316, 349, 380, 430, and 508, which may be incorporated herein.

In step 700, the controller 652 receives various generated input signals from the sensors 662, 664, 666, 668, 670, and 671. In step 700A, the controller 652 receives a vehicle speed signal generated from the vehicle speed sensor 662. In step 700B, the controller 652 receives an accelerator signal generated from the accelerator sensor 664. The accelerator signal is directly related to the desired speed, change in speed, and torque requested from a vehicle operator or as systematically determined by the controller 652, such as for autonomous vehicle control. In step 700C, the controller 652 receives an engine speed signal generated from the engine speed sensor 666. In step 700D, the controller 652 receives hydraulic pump signals generated from the hydraulic pump sensors 668. In step 700E, the controller 652 receives hydraulic drive motors signals generated from the drive motor sensors 670. In step 700F, the controller 652 receives valve position signals generated from the hydraulic valve sensors 671.

Steps 700A-700F are stated herein to provide some example sensor signals that may be utilized as inputs to the controller 652. Of course, other inputs may be provided.

In step 702, the controller 652 receives or generates various efficiency references and/or parameter relationships 684 and 686 from the memory 658. The controller 652 receives or generates an engine torque versus engine RPM reference.

In step 704, the controller 652 may determine percent engine load in response to the accelerator signal and the engine RPM signal. Note that the engine load may vary for a single engine RPM depending upon the accelerator position or, in other words, the amount of fuel being supplied to the engine. Steps 700-704 may be performed simultaneously.

In step 706, the controller 652 maintains a constant engine speed. In step 706A, the controller 652 generates a fuel input signal in response to the engine torque versus engine RPM reference and the current engine speed to maintain an approximately constant engine speed. The constant engine speed is set to provide sufficient torque to power the transmission 653 and to maintain a minimal engine speed. The controller 652 utilizes proportional-integral control logic to maintain the constant engine speed. The controller 652 compares the actual engine RPM with the desired engine RPM in order to determine the engine speed error and the direction of change. The controller 652 maintains the constant engine speed for various engine-loading conditions including during low, normal, and high loading conditions. The constant engine speed is maintained during steady state or cruising modes, during acceleration, and/or during hauling or trailering of heavy loads.

The controller 652 may utilize setpoint variables for the hydraulic pumps 674 and drive motors 676. The setpoint variables adjust the operating speed of the engine, unlike the hydraulic pump sensor and the drive motor sensor signals, which provide feedback for closed-loop control. In an example embodiment, the hydraulic pumps 674 are set at a minimum displacement and the drive motors 676 are set at a maximum displacement. During acceleration of the vehicle, the drive motors 676 are maintained at the maximum displacement and the displacement of the hydraulic pumps 674 is increased until the pumps are at full displacement. The transition from minimum displacement to full displacement of the hydraulic pumps 674 may occur at approximately 20 mph depending on pump size and motor and/or gear ratios. Upon full displacement of the hydraulic pumps 674 and maximum displacement of the drive motors 676 the motor displacements are monitored to maintain the desired engine speed.

In step 706B, the controller 652 generates a continuous variable transmission control signal in response to the engine torque versus engine RPM reference and said current engine speed to maintain the approximately constant engine speed. In step 706B1, the controller 652 generates hydraulic pump control signals, which may include desired pressures, displacements, and operating speeds of the hydraulic pumps 674. In step 706B2, the controller 652 generates drive motor control signals, which may also include desired pressures, displacements, and operating speeds of the drive motors 676. The pump and motor control signals are generated to adjust the transmission according to and in proportion to the engine speed error and the direction of adjustment desired. The pump and motor control signals are inversely related to the desired increase and decrease in engine speed. In order to increase engine speed, both the pump and motor control signals are decreased to provide additional load on the engine. Conversely, to decrease engine speed, both the pump and motor control signals are increased.

Step 706 is incorporated herein to provide examples of some output signals that may be generated by the controller 652 in response to the received input signals and the efficiency references and relationships stored. Steps 700-706 are performed continuously and reiterated to maintain the engine speed at an approximately constant value or within a desired range. The constant value or desired range may be predetermined based on the fuel efficiency and output of the engine. Although not shown in FIG. 16, steps 700-706 may also be performed continuously and reiterated to maintain the operation of the engine at maximum load for the stated constant value or desired range. The maximum load or maximum load value may also predetermined and stored in the memory 658. In general, engines operate most fuel efficiently at a maximum engine load at a given engine RPM. Although not shown in FIG. 16, steps 700-706 may also be performed accordingly to operate the hydraulic pumps 674 and the drive motors 676 at or near peak efficiency levels. In general, hydraulic pumps and drive motors have peak efficiency operation when operated at their maximum swash plate position and over a desired pressure range. Steps 700-706 may be performed many times per second or as often as the controller 652 allows.

Although it may not be possible to provide the optimum operating condition or to operate both the engine and the hydrostatic transmission at peak efficiencies and achieve operator desired speed and acceleration at constantly changes grades, road conditions, and load conditions, the above-described control techniques allow a powertrain system to maintain these peak efficiencies for a significant portion of operation and to approximate these peak efficiencies during the remainder.

The present invention provides a method of managing system parameters to use a minimum amount of input energy or fuel consumption to provide a desired input torque to a transmission at generally all times of operation or during a specified duration of operating time. The system continuously monitors the inputs and the output controls for peak efficiency settings and operation of an engine and hydrostatic transmission. The process of continuously controlling the hydraulic pumps and drive motors provides an extremely smooth and “shift-free” acceleration.

The present invention also provides a hydraulic powertrain system that eliminates the need for a high-pressure accumulator, which reduces weight and can increase fuel economy of a vehicle. This is particularly advantageous in vehicle applications, such as refuse truck applications, where small changes in vehicle weight can effect the hauling capacity and thus the profitability of a vehicle. The present invention further provides multiple efficient hydraulic motor configurations for various vehicular applications.

While the invention has been described in reference to the illustrated embodiments, it should be understood that various modifications in addition to those mentioned above will occur to persons skilled in the art. Accordingly, it will be understood that systems incorporating these and other modifications may fall within the scope of this invention, which is defined by the appended claims.

What is claimed is:

1. A method of controlling a powertrain of a vehicle comprising:
generating an engine torque versus engine revolutions per minute (RPM) reference for an engine of the powertrain;
determining a current engine speed of said engine; and
generating a fuel input signal and a continuous variable transmission control signal in response to said engine torque versus engine RPM reference and said current engine speed to maintain an approximately constant engine speed for a plurality of engine loading conditions.

2. A method as in claim 1 wherein generating said fuel input signal and said continuous variable transmission control signal comprises comparing said current engine speed with a desired engine speed and generating an error signal.

3. A method as in claim 1 further comprising:
generating a pump feedback signal;
generating a drive motor feedback signal; and
generating said fuel input signal and said continuous variable transmission control signal in response to said pump feedback signal and said drive motor feedback signal.

4. A method as in claim 1 further comprising initializing a continuous variable transmission control system comprising:
adjusting at least one hydraulic pump to be at a minimum displacement; and
adjusting at least one drive motor to be at a maximum displacement.

5. A method as in claim 4 further comprising:
increasing displacement of said at least one hydraulic pump during acceleration of the vehicle; and
maintaining said at least one drive motor at said maximum displacement.

6. A method as in claim 4 further comprising adjusting at least one of displacement and pressure of at least one drive motor to maintain said approximately constant engine speed.

7. A method as in claim 4 further comprising adjusting at least one of displacement and pressure of at least one hydraulic motor to maintain said approximately constant engine speed.

8. A method as in claim 1 further comprising adjusting at least one of displacement and pressure of at least one drive motor to maintain said approximately constant engine speed.

9. A method as in claim 1 further comprising adjusting at least one of displacement and pressure of at least one hydraulic motor to maintain said approximately constant engine speed.

10. A method as in claim 1 further comprising:
determining load on said engine; and
generating said fuel input signal and said continuous variable transmission control signal in response to said load.

11. A powertrain system control circuit comprising:
a memory having a stored engine torque versus engine rpm reference;
an engine speed sensor generating an engine speed signal; and
a controller coupled to said memory and said engine speed sensor and generating a fuel input signal and a continuous variable transmission control signal in response to said engine torque versus engine rpm reference and said engine speed signal to maintain an approximately constant engine speed for a plurality of engine loading conditions.

12. A circuit as in claim 11 wherein said controller maintains a maximum engine load for said approximately constant engine speed.

13. A circuit as in claim 11 wherein said stored engine torque versus engine rpm reference is selected from at least one of a formula, a parameter relationship, a look-up table, and an efficiency curve.

14. A circuit as in claim 11 further comprising at least one parameter sensor selected from a vehicle speed sensor, an accelerator sensor, an accelerator pedal position sensor, a pump displacement sensor, a drive motor displacement sensor, a pump pressure sensor, a drive motor pressure sensor, a hydraulic fluid pressure sensor, a pump speed sensor, and a drive motor speed sensor, and generating at least one parameter signal, said controller generating said fuel input signal and said continuous variable transmission control signal in response to said at least one parameter signal.

15. A circuit as in claim 11 wherein said controller maintain said approximately constant engine speed to be approximately between 1200-1800 revolutions per minute (RPM).

16. A circuit as in claim 11 wherein said memory has a plurality of efficiency curves stored therein, said controller generating said fuel input signal and said continuous variable transmission control signal in response to said efficiency curves.

17. A circuit as in claim 16 wherein said memory has a plurality of efficiency curves comprising continuous variable transmission efficiency curves and drive motor efficiency curves.

18. A circuit as in claim 11 wherein said controller in generating said continuous variable transmission control signal generates at least one of a hydraulic pump signal and a drive motor signal.

19. A powertrain system comprising:
an engine;
an engine speed sensor generating an engine speed signal;
at least one hydraulic pump coupled to said engine;
at least one drive motor coupled to and receiving a hydraulic fluid from said at least one hydraulic pump, said at least one drive motor supplying energy for translation of the vehicle in response to said received hydraulic fluid; and
a controller coupled to said engine, said engine speed sensor, said at least one hydraulic pump, and said at least one drive motor, and generating a fuel input signal, a hydraulic pump signal, and a drive motor signal in response to at least one efficiency reference and said engine speed signal to maintain an approximately constant engine speed for a plurality of engine loading conditions.

20. A system as in claim 19 wherein said controller generates said fuel input signal, said hydraulic pump signal, and said drive motor signal in response to an engine torque versus engine rpm efficiency reference.

21. A system as in claim 19 wherein said at least one hydraulic wheel motor comprises;
a first hydraulic motor fluidically coupled to said hydraulic pump; and
a second hydraulic motor ganged to said first hydraulic motor.
